(19) United States
(12) Patent Application Publication
(10) Pub. No.: US 2015/0218387 A1
(43) Pub. Date: Aug. 6, 2015

(54) Zinc-Magnesium Alloy Anticorrosion Pigments, Anticorrosion Paint, and Method for the Production of Said Anticorrosion Pigments

(71) Applicant: Eckart GmbH, Hartenstein (DE)

(72) Inventors: Markus Rupprecht, Edelsfeld (DE); Christian Wolfrum, Erlangen (DE); Dominik Pfammatter, Susten (CH); Mark Stoll, Zirndorf (DE); Harald Weiß, Furth (DE); Thomas Klaumünzer, Forchheim (DE)

(73) Assignee: Eckart GmbH, Hartenstein (DE)

(21) Appl. No.: 14/422,428

(22) PCT Filed: Aug. 20, 2013
(86) PCT No.: PCT/EP2013/067334

§ 371 Date: Feb. 19, 2015

(30) Foreign Application Priority Data
Aug. 20, 2012 (DE) 10 2012 107 633.2

(51) Int. Cl. C09D 5/08; B32B 15/01

(52) U.S. Cl. CPC C09D 5/084; B32B 15/017

(57) ABSTRACT

The present invention relates to platelet-shaped anticorrosion pigments, wherein the platelet-shaped zinc-magnesium alloy pigments have a composition comprising 25.1 to 76.85 mol % of Zn, 23 to 67.3 mol % of Mg, 0.15 to 7.6 mol % of Mn, Be, Y, Li, Sn and mixtures thereof, 0 to 5 mol % of Al, Ti, Fe, Cu and mixtures thereof, based in each case on the total molar amount of the elements Zn, Mg, Mn, Be, Y, Li, Sn, Al, Ti, Fe and Cu, where the molar percentages add up to 100 mol %. The invention further relates to the use and production of these pigments.

The present invention relates to platelet-shaped anticorrosion pigments, to an anticorrosion coating comprising the inventive anticorrosion pigments, to an article coated with the inventive anticorrosion pigments or with the inventive anticorrosion coating, to a process for producing the inventive platelet-shaped anticorrosion pigments, and to the use of the inventive anticorrosion pigments.

Corrosion generally refers to a chemical or electrochemical reaction of a metallic material with components from the environment. Corrosion may lead, for example, to oxidation of an article, for example a motor vehicle body, an aircraft fuselage, a bridge, etc. Corrosion of iron is also called rusting. As well as iron, a multitude of further metals or alloys can also corrode, and therefore be oxidized, for example aluminum or aluminum alloys.

Corrosion causes damage to buildings, vehicles, ships, aircraft, etc., which can result in these articles being unable to function.

If, for example, various metals having different electrochemical potential come into contact under moist conditions, for example in the presence of salt water, an electrochemical cell can thus arise. This contact results in oxidation of the base metal.

This effect can be utilized for corrosion protection, by applying a base metal as sacrificial anode to a more noble metal which is to be protected.

Under the action of moisture, the sacrificial anode is dissolved by oxidation and the more noble metal to be protected remains intact.

For example, ship's propellers made from aluminum bronze which come into contact with aggressive salt water are protected by positioning sacrificial anode blocks of zinc on the ship's propeller and along the ship's hull.

WO 2008/125610 A1 discloses a coating composition comprising zinc-bismuth alloy particles. The zinc content is at least 95% by weight, preferably at least 98% by weight. The bismuth content is within a range from 0.05% to 0.7% by weight.

WO 2010/043708 A1 discloses a method for electrochemical corrosion protection of a metallic surface, wherein there is a difference in the metal particle concentration and/or the metal particle composition at the interface facing the workpiece to be protected from corrosion and the interface facing away from the workpiece. Metallic particles used may be a multitude of different particles, for example zinc, aluminum, tin, magnesium, nickel, etc., in the form of platelets, lamellae, grains or dust.

KR 2010/023855 A discloses an anticorrosion pigment consisting, for example, of a zinc-magnesium alloy or an aluminum-magnesium alloy. In the pigments composed of the zinc-magnesium alloy, the zinc content is within a range from 90% to 99.5% by mass, and the magnesium content within a range from 10% to 0.5% by mass. Exceptionally preferably, the alloy consists of 98% by mass of zinc and 2% by mass of magnesium.

DE 10 2009 028 667 A1 discloses an anticorrosion pigment having a core-shell structure, wherein the core consists of one or more metal particles. This core has been provided with a shell having hydrophobic groups on its exterior side. The metal particles are selected from the group consisting of magnesium, zinc and aluminum. Alternatively, it is also possible to use metal alloy in the form of metal particles having a main constituent which is one of magnesium, zinc and aluminum. The core having one or more metal particles is spherical in shape.

GB 846,904 discloses a binary zinc-magnesium alloy containing 10% by weight of magnesium. This zinc-magnesium alloy is in the form of bars which is first crushed mechanically and then ground in a ball mill down to a size of 10 μm. The resultant product is in powder form.

DE 10 2007 021 602 A1 discloses zinc-magnesium alloy particles without detailed specification as anticorrosion pigments. DE 10 2008 020 216 A1 likewise discloses zinc-containing low-melting pigments without detailed specification in a method for protecting a metal from corrosion.

EP 2 246 396 A1 discloses the use of zinc-nickel, zinc-tin, zinc-iron, zinc-aluminum and zinc-aluminum-magnesium alloy as metal powder for use in corrosion protection.

U.S. Pat. No. 2,877,126 discloses the use of a metal powder composed of a binary magnesium-zinc alloy for corrosion protection. The proportion of magnesium therein is within a range between 15% and 30% by weight, and the proportion of zinc within a range from 70% to 85% by weight.

Platelet-shaped zinc pigments and zinc alloy pigments such as zinc-aluminum alloy pigments and zinc-tin alloy pigments are commercially available. They are manufactured and sold, for example, by Eckart Suisse. They are manufactured by grinding zinc powder in ball mills in petroleum spirit and typically stearic acid as lubricant. However, pure ZnMg alloy particles are currently available only in approximately spherical form obtainable from atomization. This is attributed to the fact that these particles are very brittle and are more likely to be crushed than formed in the grinding operation.

US 2004/0191555 A1 discloses anticorrosion pigments based on particulate zinc which may be alloyed with aluminum, tin, magnesium, nickel, cobalt, manganese and mixtures thereof.

EP 2 060 345 A1 discloses zinc alloy particles for use in anticorrosion paints. The zinc alloy particles may contain 0.01% to 30% by weight of magnesium. The aspect ratio of the zinc alloy particles must be between 1 and 1.5. Even an aspect ratio of more than 2 has been found to be disadvantageous.

U.S. Pat. No. 8,114,527 B2 discloses an anticorrosion coating comprising zinc alloy particles which may contain 0.1% to 30% by weight of magnesium. The anticorrosion coating contains the zinc alloy particles in a bimodal particle size distribution. The fine fraction has a particle size diameter of 0.05 to 5 μm and the coarse fraction a particle size diameter of 6 to 100 μm.

In principle, in corrosion protection, the use of platelet-shaped pigments is advantageous since platelet-shaped pigments, unlike pigments having spherical or irregular geometries, have a barrier effect after application to the article to be protected from corrosion.

Pure Zn particles can be shaped into a platelet shape, but the electrochemical potential of pure zinc is too low for such pigments to be usable as sacrificial anode for particular metals or alloys such as aluminum and alloys thereof. Alloy pigments such as ZnMg₂₆ do have sufficient electrochemical potential, but are very brittle and therefore break up extremely easily in the attempt to grind them by standard methods. For example, GB 846,904 discloses that an end product in powder form is obtained by grinding zinc-magnesium alloy particles. In this powder form, the comminuted zinc-magnesium particles are present with spherical and/or irregular geometry. Anticorrosion pigments such as chromates have been found to be highly efficient over many years in applications such as the aerospace sector, but future use appears to be impossible because of their toxicity. Accordingly, there is a need to provide novel anticorrosion pigments which, for example offer improved properties compared to the known ZnMg particles and/or can serve as a replacement for strontium chromate, for example, in fields of application such as the aerospace sector.

It is an object of the present invention to provide improved corrosion protection, especially for aluminum or aluminum alloys. More particularly, anticorrosion pigments which can be applied to an article which is to be protected from corrosion with a relatively thin pigment layer are to be provided, where the median pigment thickness should be well below 1 μm.

The object underlying the present invention is achieved by provision of platelet-shaped zinc-magnesium alloy pigments, wherein the platelet-shaped zinc-magnesium alloy pigments comprise 25.1 to 76.85 mol % of Zn, 23 to 67.3 mol % of Mg, 0.15 to 7.6 mol % of Mn, Be, Y, Li, Sn and mixtures thereof, and 0 to 5 mol % of Al, Ti, Fe, Cu and mixtures thereof, based in each case on the total molar amount of the elements Zn, Mg, Mn, Be, Y, Li, Sn, Al, Ti, Fe and Cu, where the molar percentages add up to 100 mol %.

Zinc-magnesium alloy pigments in the context of the present invention are characterized in that they consist principally of a zinc-magnesium alloy. More particularly, the aforementioned specified constituents Zn, Mg, Mn, Be, Y, Li, Sn, Al, Ti, Fe and Cu constitute at least 93% by weight, preferably at least 95% by weight, more preferably at least 96% by weight, even more preferably at least 98% by weight and most preferably at least 99% by weight of the inventive zinc-magnesium alloy pigments, based on the total weight of the zinc-magnesium alloy pigments. Examples of further constituents present are metallic, semimetallic or nonmetallic impurities or, for example, oxygen present in a superficial oxide layer. More particularly, it may be preferable that, as well as the aforementioned specified constituents, not more than 2% by weight, preferably not more than 1.5% by weight, more preferably not more than 1% by weight and even more preferably only trace constituents of other substances apart from oxygen are detectable. The percentages by weight here are based on the zinc alloy pigment. It will be appreciated that no substances which have been dried, for example, only at the surface of the zinc-magnesium alloy pigments because of the drying-out of a corresponding paste are included.

The alloy constituents of the anticorrosion pigments can be determined by means of various methods known to those skilled in the art, the exact selection of the corresponding methods being influenced by the constituents to be determined and the amounts thereof. For example, the person skilled in the art has a preference for various methods in order to determine the amount of specific substances present as a main constituent or trace constituent. Examples of test methods typically used by the person skilled in the art are ICP (inductively coupled plasma), for example coupled to MS (mass spectrometry) or OES (optical emission spectrometry), F-AES (flame atomic emission spectrophotometry), MPT-AES (microwave plasma torch atomic emission spectrometry), AAS (atomic absorption spectrometry), etc. In the course of sample preparation, substances adhering to the surface are thoroughly removed here. The person skilled in the art will be aware that slight variations in the measurement results can occur, and so the determination of several samples, for example about 10 samples, preferably 10 samples, may be necessary.

Preferred embodiments are specified in the dependent claims 2 to 10.

The object underlying the present invention is likewise achieved by provision of an anticorrosion coating comprising the inventive zinc-magnesium alloy pigments.

The object of the present invention is also achieved by provision of an article, wherein the article includes the inventive zinc-magnesium alloy pigments or an inventive anticorrosion coating.

Preferred developments of the subject matter of the invention are specified in claims 14 and 15.

The object of the invention is also achieved by provision of a process for producing platelet-shaped zinc-magnesium alloy particles as claimed in any of claims 1 to 10, wherein the process includes the following step:

mechanical forming of non-platelet-shaped zinc-magnesium alloy particles, wherein the non-platelet-shaped zinc-magnesium alloy particles comprise 25.1 to 76.85 mol % of Zn, 23 to 67.3 mol % of Mg, 0.15 to 7.6 mol % of Mn, Be, Y, Li, Sn and mixtures thereof and 0 to 5 mol % of Al, Ti, Fe, Cu and mixtures thereof, based in each case on the total molar amount of the elements Zn, Mg, Mn, Be, Y, Li, Sn, Al, Ti, Fe and Cu, where the molar percentages add up to 100 mol %.

The object is also achieved by the use of zinc-magnesium alloy pigments as claimed in any of claims 1 to 10 in the protection of an article preferably consisting of aluminum or an aluminum alloy or including aluminum or an aluminum alloy from corrosion.

The inventors have found that it is possible in a surprisingly simple manner in this way, for example, to provide platelet-shaped zinc-magnesium alloy particles, wherein the platelet-shaped zinc-magnesium alloy pigments comprise 25.1 to 76.85 mol % of Zn, 23 to 67.3 mol % of Mg, 0.15 to 7.6 mol % of Mn, Be, Y, Li, Sn and mixtures thereof and 0 to 5 mol % of Al, Ti, Fe, Cu and mixtures thereof, based in each case on the total molar amount of the elements Zn, Mg, Mn, Be, Y, Li, Sn, Al, Ti, Fe and Cu, where the molar percentages add up to 100 mol %, and the median thickness h₅₀ of the pigments is less than 1 μm, preferably less than 500 nm.

In a further preferred embodiment of the invention, the platelet-shaped zinc-magnesium alloy particles comprise 25.1 to 76.85 mol % of Zn, 23 to 67.3 mol % of Mg, 0.15 to 7.6 mol % of Mn, Be, Y, Li, Sn and mixtures thereof and 0 to 3.7 mol % of Al, Ti, Fe, Cu and mixtures thereof, based in each case on the total molar amount of the elements Zn, Mg, Mn, Be, Y, Li, Sn, Al, Ti, Fe and Cu, where the molar percentages add up to 100 mol %, and where Zn, Mg, Mn, Be, Y, Li, Sn, Al, Ti, Fe and Cu constitute a total of at least 93% by weight of the platelet-shaped zinc-magnesium alloy particles, based on the total weight thereof.

In a further preferred embodiment of the invention, the platelet-shaped zinc-magnesium alloy particles comprise 32.5 to 72.09 mol % of Zn, 27.7 to 61.8 mol % of Mg, 0.21 to 5.7 mol % of Mn, Be, Y, Li, Sn and mixtures thereof and 0 to 3.7 mol % of Al, Ti, Fe, Cu and mixtures thereof, based in each case on the total molar amount of the elements Zn, Mg, Mn, Be, Y, Li, Sn, Al, Ti, Fe and Cu, where the molar percentages add up to 100 mol %.

In a further preferred embodiment of the invention, the platelet-shaped zinc-magnesium alloy particles comprise 32.5 to 72.09 mol % of Zn, 27.7 to 61.8 mol % of Mg, 0.21 to 5.7 mol % of Mn, Be, Y, Li, Sn and mixtures thereof and 0 to 3.2 mol % of Al, Ti, Fe, Cu and mixtures thereof, based in each case on the total molar amount of the elements Zn, Mg, Mn, Be, Y, Li, Sn, Al, Ti, Fe and Cu, where the molar percentages add up to 100 mol %, and where Zn, Mg, Mn, Be, Y, Li, Sn, Al, Ti, Fe and Cu constitute a total of at least 96% by weight of the platelet-shaped zinc-magnesium alloy particles, based on the total weight thereof.

In addition, manganese has been found to be an alloy constituent of particularly good suitability for use in accordance with the invention. In further preferred embodiments of the invention, the platelet-shaped zinc-magnesium alloy pigments comprise each of Li, Be, Y and Sn in an amount of not more than 1 mol %, preferably not more than 0.7 mol %, more preferably not more than 0.4 mol %, based in each case on the molar percentages on the total molar amount of the elements Zn, Mg, Mn, Be, Y, Li, Sn, Al, Ti, Fe and Cu. It is especially preferable here when the total proportion of Li, Be, Y and Sn is not more than 2 mol %, preferably not more than 1.3 mol % and more preferably not more than 0.9 mol %.

In further preferred embodiments of the invention, the aforementioned platelet-shaped zinc-magnesium alloy pigments comprise not more than 3 mol %, preferably not more than 2.3 mol %, more preferably not more than 1.8 mol %, of Al, Ti, Fe, Cu or mixtures thereof, where the molar percentages are based on the total molar amount of the elements Zn, Mg, Mn, Be, Y, Li, Sn, Al, Ti, Fe and Cu. It is especially preferable that the aforementioned molar percentages are based on the total amount of the elements Be, Y, Li, Sn, Al, Ti, Fe and Cu. It is especially preferable here that Ti, Fe and Cu are each present in an amount of not more than 1.2 mol % and Al in an amount of not more than 1.5 mol %, preferably Ti, Fe and Cu each in an amount of not more than 0.9 mol % and Al in an amount of not more than 1.3 mol %, more preferably Ti, Fe and Cu each in an amount of not more than 0.6 mol % and Al in an amount of not more than 0.9 mol %.

In addition, in further embodiments, the proportion of Cu in the inventive platelet-shaped zinc-magnesium alloy pigments is preferably not more than 1.6 mol %, more preferably not more than 1.2 mol %, even more preferably not more than 0.9 mol % and even more preferably not more than 0.4 mol %, where the molar percentages are based on the total molar amount of the elements Zn, Mg, Mn, Be, Y, Li, Sn, Al, Ti, Fe and Cu. It may be especially preferable that copper can be detected only as a trace constituent, if at all.

In further preferred embodiments, the pigments comprise manganese in an amount from a range from 0.24 to 5.8 mol %, preferably from 0.27 to 4.9 mol %, even further preferably from 0.31 to 4.3 mol %, even further preferably from 0.36 to 3.6 mol %, even further preferably from 0.4 to 3.1 mol %, even further preferably about 0.8 mol %, where the molar percentages are based on the total molar amount of the elements Zn, Mg, Mn, Be, Y, Li, Sn, Al, Ti, Fe and Cu.

The inventors have surprisingly succeeded in providing zinc-magnesium alloy pigments which are based on zinc and magnesium and are producible in a particularly simple manner, in platelet form, regardless of the brittleness of a zinc-magnesium alloy. Thus, it has been found that, surprisingly, the ductility of the inventive zinc-magnesium alloy particles can be enhanced significantly when at least one further alloy component which is selected from the group consisting of manganese, beryllium, yttrium, lithium, tin and mixtures thereof is added to alloys of this kind in a suitable amount. Preferably, the alloy for use in accordance with the invention is a zinc-magnesium alloy comprising 25.1 to 76.85 mol % of Zn, 23 to 67.3 mol % of Mg, 0.15 to 7.6 mol % of Mn, Be, Y, Li, Sn and mixtures thereof and 0 to 5 mol % of Al, Ti, Fe, Cu and mixtures thereof, where the amount of Be, Y, Li, Sn or mixtures thereof is not more than 2 mol %, preferably not more than 1 mol %, based in each case on the total molar amount of the elements Zn, Mg, Mn, Be, Y, Li, Sn, Al, Ti, Fe and Cu, where the molar percentages add up to 100 mol %.

The inventive platelet-shaped zinc-magnesium alloy pigments based on the alloy which is to be used in accordance with the invention and has a proportion of 25.1 to 76.85 mol % of zinc, 23 to 67.3 mol % of magnesium, 0.15 to 7.6 mol %, preferably 0.15 to 6.3 mol %, of at least one further alloy component which is selected from the group consisting of manganese, beryllium, yttrium, lithium, tin and mixtures thereof, and optionally 0 to 5 mol %, preferably 0 to 3.7 mol %, of aluminum, titanium, iron, copper and mixtures thereof, based in each case on the total molar amount of the elements Zn, Mg, Mn, Be, Y, Li, Sn, Al, Ti, Fe and Cu, where the molar percentages add up to 100 mol %, enable the provision of improved corrosion protection.

Under standard conditions (25° C., 1013.25 mbar, pH 0), zinc has a standard electrochemical potential of −0.76 V. Magnesium under standard conditions has a standard electrochemical potential of −2.362 V. Therefore, magnesium has a more negative standard electrochemical potential than zinc. At a proportion of 23 to 67.3 mol % of magnesium, based on the total molar amount of the elements Zn, Mg, Mn, Be, Y, Li, Sn, Al, Ti, Fe and Cu, in the alloy which is based on the main constituents zinc and magnesium and is to be used in accordance with the invention, the standard electrochemical potential of the platelet-shaped zinc-magnesium alloy pigments is lowered below that of pure zinc. Exceptionally advantageously, the chemical reactivity of the alloy based predominantly on zinc and magnesium is not increased too significantly by the proportion of magnesium. Too great a reactivity of anticorrosion pigments leads to rapid consumption of the zinc-magnesium alloy pigments and, as a result, to a greater time restriction in corrosion protection.

It has been found that, with a proportion of 23 to 67.3 mol % of magnesium, based on the total molar amount of the elements Zn, Mg, Mn, Be, Y, Li, Sn, Al, Ti, Fe and Cu, in the zinc- and magnesium-based alloy to be used in accordance with the invention, improved corrosion protection is firstly obtained because of the proportion of magnesium, and sufficiently long-lived corrosion protection can secondly be provided.

The obligatory third component serves essentially to increase the ductility of the alloy for use in accordance with the invention. The increased ductility allows the provision of platelet-shaped zinc-magnesium alloy pigments through mechanical forming. In addition, the alloy for use in accordance with the invention enables the provision of extremely thin platelets within a relatively short period, compared to an alloy consisting exclusively of zinc and magnesium. A further significant advantage of the composition for use in accordance with the invention is that, because of the increased ductility, the mechanical forming of the particles to give the platelet-shaped zinc-magnesium alloy pigments can be brought about with various apparatuses, for example ball mills, three-roll mills, drum mills, stirred ball mills, vibratory mills, pan mills, attritors, etc.

Preferably, the zinc- and magnesium-based alloy to be used in accordance with the invention is a ternary zinc-magnesium-manganese alloy.

The substances present in the inventive zinc-magnesium alloys alongside Zn, Mg, Mn, Be, Y, Li, Sn, Al, Ti, Fe and Cu may be nonmetals, semimetals and nonmetals. Examples of the aforementioned semimetals are B, Ge and Si. Examples of the metals are lead, calcium, strontium, barium, sodium, potassium, bismuth, indium, cerium, tellurium, silver, mercury, iron, cobalt, nickel, chromium, niobium, vanadium, molybdenum, tantalum, osmium, tungsten, zirconium, gold, platinum, cadmium, lanthanum, gallium. Examples of corresponding nonmetals are carbon, nitrogen and oxygen. These substances may have been present, for example, as impurities in the metals used. Nonmetals we oxygen may be bound, for example, in the form of an oxide layer on the surface.

The use of beryllium is only of limited desirability because of its toxicity, since relatively large amounts could be used only for limited fields of application and, therefore, strict product separation with a high level of complexity may not be very attractive. Moreover, there is a risk that the availability of lithium could become disrupted in future as a result of development with regard to battery systems. Therefore, it may be preferable in the aforementioned embodiments that the amount of Be or Li in the inventive platelet-shaped anticorrosion pigments is not more than 1.5 mol %, preferably not more than 1.1 mol %, more preferably not more than 0.7 mol %, even more preferably not more than not more than 0.4 mol %. More preferably, this applies both to lithium and beryllium.

In particular, it is preferable that the platelet-shaped zinc-magnesium alloy pigments aluminum in an amount of less than 1.3 mol %, preferably of less than 0.9 mol %, even further preferably of less than 0.6 mol %, based on the total molar amount of the elements Zn, Mg, Mn, Be, Y, Li, Sn, Al, Ti, Fe and Cu. More particularly, it is preferable when the amount of aluminum is below the detection limit.

In a further preferred embodiment of the invention, the platelet-shaped zinc-magnesium alloy pigments comprise 38.8 to 68.57 mol % of zinc, 31.2 to 55.7 mol % of magnesium and 0.18 to 6.3 mol %, preferably 0.21 to 5.7 mol %, even further preferably 0.23 to 5.5 mol %, of manganese, beryllium, yttrium, lithium and/or tin, preferably manganese, and 0 to 4.2 mol %, preferably 0 to 3.7 mol %, even further preferably 0 to 3.5% by weight, of aluminum, titanium, iron and/or copper, where the molar percentages are based on the total molar amount of the elements Zn, Mg, Mn, Be, Y, Li, Sn, Al, Ti, Fe and Cu, and the molar percentages add up to 100 mol %.

Further preferred platelet-shaped zinc-magnesium alloy pigments are those which include 42.2 to 56.4 mol % of zinc and 41.6 to 55.2 mol % of magnesium, 0.18 to 6.3 mol %, even further preferably 0.21 to 5.7 mol %, of manganese, beryllium, yttrium, lithium and/or tin, where the proportion of Be, Y, Li and Sn preferably totals not more than 1.5 mol %, and 0 to 4.2 mol %, preferably 0 to 3.7 mol %, even further preferably 0 to 3.5 mol %, of aluminum, titanium, iron and/or copper, where the molar percentages are based on the total molar amount of the elements Zn, Mg, Mn, Be, Y, Li, Sn, Al, Ti, Fe and Cu, and the molar percentages add up to 100 mol %. It is especially preferable here that Zn, Mg, Mn, Be, Y, Li, Sn, Al, Ti, Fe and Cu constitute at least 95% by weight of the inventive platelet-shaped zinc-magnesium alloy pigments.

Further preferred platelet-shaped zinc-magnesium alloy pigments are those which include 43.8 to 53.2 mol % of zinc and 42.7 to 51.9 mol % of magnesium and 0.21 to 5.7 mol %, even further preferably 0.23 to 5.5 mol %, of manganese, beryllium, yttrium, lithium and/or tin, where the proportion of Be, Y, Li and Sn preferably totals not more than 0.8 mol %, and optionally 0 to 4.2 mol %, preferably 0% to 3.7% by weight, even further preferably 0% to 3.5% by weight, of aluminum, titanium, iron and/or copper, where the molar percentages are based on the total molar amount of the elements Zn, Mg, Mn, Be, Y, Li, Sn, Al, Ti, Fe and Cu, and the molar percentages add up to 100 mol %.

Particularly good anticorrosive properties seem to be achieved for zinc-magnesium alloy pigments which feature a particular ratio of zinc to magnesium. It is suspected here that this can be attributed to formation of specific intermetallic phases and/or specific separation. In particular embodiments, it is preferable that the molar ratio of zinc to magnesium is within a range from preferably 0.75:1 to 1.35:1, preferably within a range from 0.85:1 to 1.25:1, more preferably within a range from 0.9:1 to 1.2:1, even more preferably within a range from 0.93:1 to 1.15:1.

The amount of Al, Ti, Fe and Cu in the inventive platelet-shaped anticorrosion pigments is not more than 5 mol %, preferably not more than 4.2 mol %, more preferably not more than 3.7 mol %, even more preferably not more than 3.5 mol %, where the molar percentages are based on the total molar amount of the elements Zn, Mg, Mn, Be, Y, Li, Sn, Al, Ti, Fe and Cu. It is especially preferable here that the proportions of each of Ti, Fe and Cu are not more than 1.3 mol %, preferably not more than 1 mol % and more preferably not more than 0.8 mol %.

A very suitable alloy in the context of the invention has been found to be one having a proportion of 44.2 to 52.1 mol % of Zn, 43.3 to 50.9 mol % of Mg, 0.37 to 5 mol % of Mn, Be, Y, Li and/or Sn, 0 to 4.2 mol % of Al, Ti, Fe and/or Cu, where the proportions of each of Be, Y, Li and Sn are below 1 mol % and the proportions of each of Ti, Fe and Cu are below 0.8 mol %, where the molar percentages are based on the total molar amount of the elements Zn, Mg, Mn, Be, Y, Li, Sn, Al, Ti, Fe and Cu.

The figures in mol % above and below should be understood with the proviso that, even in the event of restriction of the claims to preferred ranges and components, all the components specified in the original claim 1 are present only in such proportions that the total proportion of all the specified components of the zinc-magnesium alloy is within the ranges of 25.1 to 76.85 mol % of Zn, 23 to 67.3 mol % of Mg, 0.15 to 7.6 mol % of Mn, Li, Be, Y, Sn and mixtures thereof, and 0 to 5 mol % of Al, Ti, Fe, Cu and mixtures thereof, where the molar percentages are based on the total molar amount of the elements Zn, Mg, Mn, Be, Y, Li, Sn, Al, Ti, Fe and Cu, and the molar percentages add up to 100 mol %.

Surprisingly, therefore, the particularly simple provision of platelet-shaped zinc-magnesium alloy pigments having a median thickness well below 1 μm, preferably of less than 700 nm, is possible. Even the provision of platelet-shaped magnesium-containing zinc pigments having corresponding contents of zinc and magnesium is astonishing, since a high degree of brittleness is expected in the case of an alloy based on zinc and magnesium as main components, and this counteracts mechanical forming to give platelets. The additional proportion of manganese, beryllium, yttrium, lithium and/or tin, especially of manganese, surprisingly generates ductility which enables the production of platelet-shaped pigments in a surprisingly simple manner. However, it was entirely unexpected that it is possible in accordance with the invention to provide not just platelet-shaped magnesium-containing zinc pigments but also platelet-shaped magnesium-containing zinc pigments having exceptionally low thicknesses or very thin magnesium-containing zinc pigments under standard conditions within a short time.

Surprisingly, the inventive alloy composition can be formed to platelets in conventional ball mills, for example, without any significant abrasion or the production of irregularly shaped particles.

Moreover, it was found that it is possible, both in the case of use of a ball mill and in the case of use of a stirred ball mill, to achieve homogeneous grinding with distinctly reduced fracture of the larger particles.

The term “stirred ball mill” in the context of the present invention means that the mill has a rotor within, which sets the grinding bodies, preferably balls, in motion or contributes to the movement thereof. A specific form of the stirred ball mill has a rotor within, while the outer wall rotates at the same time.

In particular preferred embodiments, it is a characteristic feature of the inventive zinc-magnesium pigments that they have a median thickness of less than 1 μm, preferably less than 900 nm, more preferably less than 700 nm, more preferably less than 500 nm, even more preferably less than 350 nm and most preferably less than 300 mm.

Preference is given in accordance with the invention to providing platelet-shaped zinc-magnesium alloy pigments having a median thickness from a range from 70 nm to less than 900 nm.

In a further preferred embodiment, the median thickness of the zinc-magnesium alloy pigments is within a range from 70 nm to less than 700 nm, even further preferably from 80 nm to less than 500 nm. Another very suitable thickness has been found to be one from a range from 90 nm to less than 350 nm. Exceptionally preferably, the median thickness is within a range from 100 nm to less than 300 nm.

The median thickness of the zinc-magnesium alloy pigments can be determined from a thickness distribution found via thickness counting by scanning electron microscopy (SEM), viewed as a cumulative frequency distribution. In this method, by means of scanning electron microscopy (SEM), a number of particles sufficient that a representative statistical evaluation can be undertaken are analyzed. Typically about 100 particles, preferably 100 particles, are analyzed.

The thickness distribution is appropriately determined in the form of a cumulative frequency distribution curve. The median value is given by the h₅₀ value of the cumulative frequency distribution. A measure of the proportion of the thicker pigments is the h₉₀ value. This value means that 90% of all the pigment particles have a thickness equal to and/or below this value. Analogously, the h₁₀ value is a measure of the proportion of the thinner pigments in the thickness distribution, which means that 10% of all the pigment particles have a thickness equal to and/or below this value. The h₅₀ value consequently gives the median thickness value, meaning that 50% of all the pigment particles have a thickness equal to and/or below this value.

The measurement of thickness of the individual pigments by means of SEM and the calculation of the median thickness are effected by the method described in DE 10 315 775 A1.

In summary, the thickness of the zinc-magnesium alloy pigments can be determined by means of SEM as follows:

The inventive platelet-shaped zinc-magnesium alloy pigments are first washed with acetone and then dried.

A resin customary in electron microscopy, for example TEMPFIX (Gerhard Neubauer Chemikalien, D-48031 Münster, Germany), is applied to a sample stage and is heated on a hotplate until it softens. Subsequently, the sample stage is removed from the hotplate and the zinc-magnesium alloy pigments are scattered onto the softened resin. The resin solidifies again as a result of the cooling, and the zinc-magnesium alloy pigments scattered on—as a result of the interplay between adhesion and gravity—can be prepared in virtually upright and fixed form on the sample stage. As a result, the pigments have good lateral analyzability in an electron microscope. In the analysis of the thickness, the azimuthal angle a of the pigment is estimated relative to a plane normal to the surface, and is taken into account in the thickness evaluation by the formula

h_{eff}=hₘₑₐₛ/cos α.

The cumulative distribution curve is drawn with the h_{eff} values using the relative frequencies. About 100 pigments, preferably 100 pigments, are counted.

If the aforementioned process variant is not usable, the thicknesses of the pigments can can also be counted, for example, using polished sections of painted samples. However, this method should be employed only in the case of very good plane-parallel orientation of the pigments. Otherwise, the pigments in the polished section may be oriented with an azimuthal angle of inclination, but one which is not apparent to the observer. This leads to a systematic measurement of higher thicknesses.

The provision of platelet-shaped anticorrosion pigments having the above-specified low median thicknesses allows the provision of an anticorrosion coating in which the total thickness can be significantly reduced. This enables the use of the inventive pigments especially in anticorrosion applications with very thin coatings, for example aircraft coatings or coil coating.

Because of the low thickness of the inventive platelet-shaped zinc-magnesium alloy pigments, the hiding capacity of the inventive platelet-shaped anticorrosion pigments, i.e. the coverage of the area per unit weight of pigment, is very high. Given the same weight, for example 1 g of pigment, thinner platelet-shaped zinc-magnesium alloy pigments have a higher hiding capacity than platelet-shaped zinc-magnesium alloy pigments having a greater thickness, since the number of platelet-shaped pigments per unit weight is higher in the case of thinner platelet-shaped zinc-magnesium alloy pigments than in the case of thicker platelet-shaped zinc-magnesium alloy pigments. The thinner platelet-shaped zinc-magnesium alloy pigments, in the article to be protected from corrosion, for example an aircraft fuselage or a vehicle body, can be arranged alongside one another and one on top of another such that, firstly, extremely effective barrier protection is built up and, secondly, the article to be protected from corrosion are reliably covered by the platelet-shaped zinc-magnesium alloy pigments having low thickness.

In a further preferred embodiment of the invention, the platelet-shaped zinc-magnesium alloy pigments have a median diameter D₅₀ from a range from 4 to 35 μm, further preferably from 4.5 to 30 μm, even further preferably from 5 to 25 μm. Another very suitable median diameter has been found to be one from 5 to 18 μm.

In a further preferred embodiment, the platelet-shaped zinc-magnesium alloy pigments have a size distribution having a span ΔD according to the formula (I) span ΔD=(D₉₀−D₁₀)/D₅₀ of 1 to 2.3. Further preferably, the span is 1.2 to 2.1, even further preferably 1.3 to 1.9.

The span ΔD is a characterization of the breadth of the particle size distribution. The smaller the span, the narrower the particle size distribution.

The D₁₀, D₅₀ and D₉₀ values of the cumulative frequency distribution of the inventive anticorrosion pigments, as obtained by laser diffraction methods, indicate that, respectively, 10%, 50% and 90% of the zinc-magnesium alloy pigments have a diameter equal to or less than the value specified in each case. The size distribution curve can be determined with a Malvern instrument (instrument: Malvern Mastersizer 2000) according to the manufacturer's instructions. The scattered light signals are evaluated by the Mie theory.

In a preferred development of the invention, the D₁₀ value is within a range from 0.9 μm to 6 μm, further preferably from 1.1 μm to 5.2 μm, even further preferably from 1.2 μm to 4.3 μm. The greater the D₁₀ value, the smaller the fines fraction should be.

It is additionally preferable that the D₅₀ value is within a range from 3.0 μm to 25.0 μm, further preferably from 3.5 μm to 20 μm, even further preferably from 4 μm to 14 μm.

It is additionally preferable that the D₉₀ value is within a range from 5 μm to 40, further preferably from 5.5 μm to 30 μm, even further preferably from 6 to 25 μm.

In a further preferred embodiment of the invention, the platelet-shaped zinc-magnesium alloy pigments have only such a combination of D₁₀, D₅₀ and D₉₀ values that the span ΔD is within the above-specified ranges. The D₁₀ value is a measure of the fines fraction in a particle size distribution.

The inventive platelet-shaped zinc-magnesium alloy pigments typically have an extremely low proportion of non-platelet-shaped particles, for example in the form of abraded material or irregularly shaped fragments.

Because of the extremely low proportion of spherical and/or irregularly shaped particles in the inventive platelet-shaped anticorrosion pigments, the platelet shape of the zinc-magnesium alloy pigments results firstly in an improvement in barrier action and secondly in improved sacrificial anode action.

Preferably, the aspect ratio, i.e. the ratio of median pigment diameter (D₅₀) to median pigment thickness (h₅₀), is within a range from 10 to 200, further preferably from 12 to 100, further preferably from 15 to 75, even further preferably from 18 to 50, even further preferably from 20 to 40.

Particularly preferred inventive zinc-magnesium alloy pigments have a composition of 32.5 to 72.09 mol % of Zn, 27.7 to 61.8 mol % of Mg, 0.21 to 5.7 mol % of Mn, Li, Be, Y and/or Sn, 0 to 4.2 mol % of Al, Ti, Fe and/or Cu, and a median thickness of 90 nm to less than 350 nm, where the proportions of each of Li, Be, Y, Sn are not more than 1 mol % and the proportions of each of Ti, Fe and Cu are not more than 0.8 mol %, where the molar percentages are based on the total molar amount of the elements Zn, Mg, Mn, Be, Y, Li, Sn, Al, Ti, Fe and Cu, and the molar percentages add up to 100 mol %, and where Zn, Mg, Mn, Be, Y, Li, Sn, Al, Ti, Fe and Cu constitute at least 95% by weight of the inventive platelet-shaped zinc-magnesium alloy pigments.

Very particularly preferred platelet-shaped zinc-magnesium alloy pigments have a composition of 38.8 to 68.57 mol % of Zn, 31.2 to 55.7 mol % of Mg, 0.21 to 5.7 mol % of Mn, Li, Be, Y and/or Sn, 0 to 3.7 mol % of Al, Ti, Fe and/or Cu, and a median thickness of 90 nm to 350 nm, where the proportions of each of Li, Be, Y, Sn are not more than 0.7 mol %, the proportion of Al is not more than 1.3 mol % and the proportions of each of Ti, Fe and Cu are not more than 0.6 mol %, where the molar percentages are based on the total molar amount of the elements Zn, Mg, Mn, Be, Y, Li, Sn, Al, Ti, Fe and Cu, and the molar percentages add up to 100 mol %, and Zn, Mg, Mn, Be, Y, Li, Sn, Al, Ti, Fe and Cu constitute at least 96% by weight of the inventive platelet-shaped zinc-magnesium alloy pigments.

The respective alloy is produced by melting the corresponding alloy constituents, taking account of the respective melting temperature (zinc: about 420° C., magnesium: about 650° C., manganese: about 1246° C., beryllium: about 1278° C., yttrium: 1526° C., lithium: about 181° C., tin: about 232° C.).

A homogeneous melt is produced from the zinc, magnesium and further component(s) under inert gas, preferably argon. The melt is then atomized in a conventional manner under inert gas, preferably under argon, to obtain an alloy powder. Inclusions of elemental metal or intermetallic phases may form in the resultant alloy powder. The powder is preferably in spherical form. The inventive platelet-shaped zinc-magnesium alloy pigments can be produced by mechanical forming from the alloy powder thus obtained.

In a further preferred embodiment, the platelet-shaped zinc-magnesium alloy pigments have been obtained by mechanical forming.

In principle, it is possible to produce platelet-shaped zinc-magnesium alloy pigments via physical vapor deposition. The defined vaporization of zinc metal, magnesium metal and of one or more further components, for example manganese, to obtain a specified alloy is technically complex and associated with very high costs. However, anticorrosion pigments are a material used in large volumes, which has to be producible inexpensively. In this respect, the production of the platelet-shaped zinc-magnesium alloy pigments via physical vapor deposition is a possible route, but not one which enables a marketable product because of its costs.

Therefore, it is preferable to produce the inventive platelet-shaped zinc-magnesium alloy pigments by mechanical forming. The platelet-shaped zinc-magnesium alloy pigments produced by mechanical forming differ structurally from the platelet-shaped anticorrosion pigments produced by physical vapor deposition by the nature of the surface. By means of physical vapor deposition, pigments having an absolutely planar surface are obtained. In addition, the metallic pigments produced via physical vapor deposition have straight fracture edges after detachment from the carrier material.

The inventive platelet-shaped zinc-magnesium alloy pigments produced by mechanical forming are firstly notable for a surface that is not absolutely planar, but instead for a surface which is slightly corrugated. In addition, the platelet-shaped zinc-magnesium alloy pigments produced by mechanical forming have rounded edge regions having slight edge cracks. In structural terms, therefore, platelet-shaped zinc-magnesium alloy pigments produced by physical vapor deposition can be differentiated easily from platelet-shaped zinc-magnesium alloy pigments obtained by mechanical forming, for example by means of scanning electron microscopy (SEM).

According to the invention, it is possible to produce platelet-shaped zinc-magnesium alloy pigments inexpensively by mechanical forming. In corrosion protection, the optical properties of the pigments are not particularly important. Instead, the platelet-shaped structure of the pigments is essential for effective corrosion protection. The fact that the platelet-shaped zinc-magnesium alloy pigments produced by mechanical forming have a much less homogeneous surface is not disadvantageous for effective corrosion protection.

The present invention further provides an anticorrosion coating comprising the inventive platelet-shaped zinc-magnesium alloy pigments.

The inventive zinc-magnesium alloy pigments can be incorporated into a wide variety of different coating compositions, for example paints and coatings.

The proportion of the zinc-magnesium alloy pigments can be adjusted according to the respective profile of requirements in the anticorrosion coating. Typically, the proportion of the zinc-magnesium alloy pigments in the anticorrosion coating is preferably within a range from 10% to 80% by weight, further preferably from 15% to 70% by weight, even further preferably from 20% by weight to 65% by weight, based on the total weight of the anticorrosion coating.

The proportion of binder in the anticorrosion coating is preferably within a range from 15% to 85% by weight, further preferably from 25% to 75% by weight, even further preferably from 35% to 70% by weight, based on the total weight of the anticorrosion coating.

In the case of a coating or paint, the proportion of solvent in the anticorrosion coating is preferably within a range from 1% to 10% by weight, further preferably from 2% to 8% by weight, even further preferably from 2% by weight to 5% by weight. Water may also be present in the organic solvent. Preferably, the water content, based on the total weight of the solvent, is less than 1% by weight, further preferably less than 0.9% by weight, even further preferably less than 0.8% by weight.

The above-specified composition of the anticorrosion coating is the composition to be applied, and therefore not the dried composition.

Solvents used may be the organic solvents typically used in paints and coatings, for example ethoxypropyl acetate, methyl ethyl ketone, methyl isobutyl ketone, ethyl acetate, butyl acetate, xylene, acetone and mixtures thereof.

The inventive anticorrosion coating may take the form of a one-pack system (1K) or of a two-pack system (2K).

The anticorrosion coating may also take the form of an anodic or cathodic dipcoat.

In a further development of the invention, the inventive anticorrosion coating takes the form of a powder coat.

The inventive platelet-shaped zinc-magnesium alloy pigments are extremely versatile in terms of use, and can therefore be incorporated into a wide variety of different coating compositions.

Binders used in conjunction with the inventive platelet-shaped anticorrosion pigments may be all the customary paint binders and coating binders. The binders used in each case are selected as a function of the solvent and/or the respective coating method.

In the case of powder coatings, preference is given to using thermoplastic or thermoset resins as binders.

For example, thermoplastic binders used may be polyvinyl chloride, polyamides, polyethylenes, polypropylenes, polyvinylidene fluorides and other thermoplastic resins.

Thermoset or heat-curable binders used may, for example, be epoxy resins, polyurethane resins, polyester resins, acrylate resins, etc.

Epoxy resins and polyurethane resins have been found to be very suitable, for example for use in powder coats. In addition, epoxy resins on the one hand and polyurethane resins on the other hand are used especially as binder systems for the exterior finishing of aircraft. For example, it is possible to use the binder systems sold by Sherwin-Williams, USA, or the binder systems sold by DuPont, USA.

The inventive anticorrosion coatings may comprise the customary additives, for example wetting agents or dispersants, surface additives, matting agents, rheology additives, light stabilizers, for example UV stabilizers, desiccants, biocides or mixtures thereof.

The inventive platelet-shaped zinc-magnesium alloy pigments should in principle be applied to all customary substrates as anticorrosion paint. Preferably, however, they are applied to specific substrates, especially comprising base metals such as aluminum alloys. Examples of corresponding aluminum alloys are AA2024, AA5754. Since the standard potential of aluminum is lower than that of zinc, zinc platelets (or zinc dust) cannot be used here.

The inventive platelet-shaped zinc-magnesium alloy pigments, in a preferred embodiment of the invention, are suitable for use in belt coating, also called coil coating, of, for example, aluminum coils, aluminum alloy coils or steel coils, or aluminum sheets, aluminum alloy sheets or steel sheets.

The sheets coated by means of coil coating find various uses, for example in facades, roofing elements or domestic appliances, for example refrigerators, washing machines, dishwashers, etc.

Because of the extremely low thickness of the inventive zinc-magnesium alloy pigments within a range from 70 nm to less than 900 nm, as stated above, it is possible to apply an anticorrosion coating having a total dry thickness of preferably 10 to 200 μm, preferably of 25 to 150 μm, further preferably of 30 to 100 μm. A very suitable total dry thickness has been found to be one from 10 to 40 μm.

It has been found that, surprisingly, anticorrosion coatings, preferably based on epoxy resin or based on polyurethane resin, comprising the inventive platelet-shaped anticorrosion pigments, preferably in a median thickness of about 80 nm to less than 500 nm, further preferably from about 90 nm to less than 350 nm, even further preferably from 100 nm to less than 300 nm, are particularly suitable for the coating of aircraft.

Anticorrosion coatings in aircraft are exposed to extreme conditions. For example, these anticorrosion coatings have to withstand temperature changes from +70° C. to −60° C. within a few minutes. It is also necessary that the aircraft paints are resistant to the intense UV radiation which occurs at cruising altitude. Finally, aircraft paints also have to be resistant to chemical and mechanical stresses, for example to kerosene and hydraulic fluid, grains of sand, ice crystals and vibrating wings.

The inventive platelet-shaped zinc-magnesium alloy pigments are especially suitable for use as zinc-magnesium alloy pigments in paints for finishing of aircraft.

In order to keep the total weight of an aircraft low with respect to the requisite stability, aluminum alloys are used in aircraft construction. One aluminum alloy employed is the aluminum alloy referred to as AA2024. The aluminum alloy AA2024 has a density of 2.78 g/cm³ and contains, in aluminum, about 4.3% to 4.4% by weight of copper, 0.5% to 0.6% by weight of manganese, 1.3% to 1.5% by weight of magnesium and less than about 0.5% by weight of zinc, nickel, chromium, lead and bismuth. Typically, the composition of the aluminum alloy AA2024 is reported as AlCu₄Mg₁. This aluminum alloy has the mechanical properties required for aircraft construction, but poor corrosion resistance.

A further aluminum alloy, AA5754, which is also employed in automobile construction and shipbuilding, has a density of about 2.66 g/cm³ and contains, in aluminum, 2.6% to 3.6% by weight of magnesium, 0.5% by weight of manganese, 0.4% by weight of iron, 0.4% by weight of Si, 0.3% by weight of Cr, 0.2% by weight of Zn, 0.15% by weight of Ti and 0.1% by weight of Cu. Typically, the composition of the aluminum alloy AA5754 is reported as AlMg₃.

The standard electrochemical potential of zinc is −0.76 V, whereas the standard electrochemical potential of aluminum is −1.66 V. Therefore, zinc is nobler than aluminum, which is why aluminum would be dissolved in the event of direct contact of zinc and aluminum under moist conditions, for example.

The standard electrochemical potential in the case of the inventive platelet-shaped zinc-magnesium alloy pigments is formed essentially by zinc and magnesium, which are the two main constituents of the alloys used in accordance with the invention.

The standard electrochemical potential of manganese is −1.18 V, that of beryllium −1.85 V, that of yttrium −2.37 V, that of lithium −3.04 V and that of tin −0.14 V. Since these metals, however, are present in a maximum proportion of 7.6 mol % in the alloy to be used, their influence on the standard electrochemical potential is low. This is especially true when the proportion of the aforementioned components in the alloy is within a range from 0.18 to 6.3 mol %, preferably from 0.21 to 5.7 mol %, even further preferably from 0.24 to 5.2 mol %, based in each case on the total molar amount of the elements Zn, Mg, Mn, Be, Y, Li, Sn, Al, Ti, Fe and Cu.

Through the increase in the proportion of magnesium in the alloy used in accordance with the invention, it is possible to lower the standard electrochemical potential, such that there is effective corrosion protection, especially with respect to the aluminum alloys used in aircraft construction.

By virtue of the platelet-shaped structure of the inventive zinc-magnesium alloy pigments, they can firstly serve in a physically effective manner as a barrier, and secondly can serve effectively as a sacrificial anode, as a result of the two-dimensional contact with the article to be protected from corrosion, for example an aircraft fuselage or ship's hull or a chassis.

Because of the extremely low pigment thickness of the inventive platelet-shaped zinc-magnesium alloy pigments, the inventive platelet-shaped zinc-magnesium alloy pigments can be used in extremely thin coatings, as required in aircraft coatings, for example, with layer thicknesses of about 30 μm or less.

Since the inventive platelet-shaped zinc-magnesium alloy pigments preferably have a median thickness of less than 1 μm, preferably of less than 700 nm, the inventive platelet-shaped zinc-magnesium alloy pigments may be stacked alongside one another and especially one on top of another in multiple layers in the anticorrosion coating, so as to form an extremely effective physical barrier. Given a paint layer thickness of 30 μm, it is therefore possible, given a median thickness of not more than 1 μm, for example, for an average of up to 30 layers of inventive platelet-shaped anticorrosion pigments to be arranged one on top of another, which brings about extremely effective corrosion protection.

The inventive platelet-shaped zinc-magnesium alloy pigments can of course be employed not just in aircraft paint systems, but also in paint systems for ships or boats and also in vehicle bodies. Vehicle bodies are understood to mean motor vehicle bodies in automobiles, in trucks, and also in motorbikes or scooters.

It is likewise possible to use the inventive platelet-shaped zinc-magnesium alloy pigments in corrosion protection of buildings, facades, door and window frames, bridges, wind turbines, power masts, etc.

As a result, the object underlying the invention is also achieved by an article coated with the inventive platelet-shaped anticorrosion pigments or the inventive anticorrosion coating. The inventive article is selected from the group consisting of aircraft, ships, boats, vehicle bodies, cans, wall claddings made of metal, especially of aluminum, bicycles, buildings, facades, door and window frames, power masts, wind turbines and bridges.

Particular preference is given to articles made from aluminum or aluminum alloy or articles which have been endowed with aluminum or an aluminum alloy. Therefore, the articles are preferably aircraft, ships, boats or vehicle bodies, especially preferably aircraft.

The object underlying the invention is also achieved by a process for producing the inventive platelet-shaped zinc-magnesium alloy pigments. This process has the following step:

mechanical forming of non-platelet-shaped metal particles, wherein the non-platelet-shaped metal particles comprise 25.1 to 76.85 mol % of Zn, 23 to 67.3 mol % of Mg, 0.15 to 7.6 mol % of Mn, Be, Y, Li, Sn and mixtures thereof, and 0 to 5 mol % of Al, Ti, Fe, Cu and mixtures thereof,

based in each case on the total molar amount of the elements Zn, Mg, Mn, Be, Y, Li, Sn, Al, Ti, Fe and Cu, where the molar percentages add up to 100 mol %, preferably using grinding bodies, into a platelet shape.

As already explained above, the alloys used for production of the inventive platelet-shaped zinc-magnesium alloy pigments are ductile, and so, regardless of the high zinc and magnesium content, particles, which are preferably spherical, have good mechanical formability. The mechanical forming can be conducted in a conventional ball mill. It is also possible to use, for example, a stirred ball mill or a three-roll mill.

In the process according to the invention, non-platelet-shaped metal particles preferably having an approximately spherical geometry are used. The non-platelet-shaped metal particles of the alloy used in accordance with the invention, which preferably have an approximately spherical geometry, are obtained by atomizing a metal alloy melt in a conventional manner by atomization. The metal particles obtained after the atomization of the melt are generally spherical and have a median particle diameter within a range from 2 μm to 100 μm, further preferably from 5 μm to 80 μm, even further preferably from 10 μm to 40 μm.

Preferably, the metal powder obtained by atomization has a narrow particle size distribution. It is preferable that the spherical metal particles of the alloy for use in accordance with the invention have a D₁₀ value of 0.9 μm to 6 μm, preferably of 1.2 to 4.3, a D₅₀ value of 3 μm to 25 μm, preferably of 4 μm to 14 μm, and a D₉₀ value of 5 μm to 40 μm, preferably of 6 μm to 25 μm.

In a preferred development of the process according to the invention, the grinding unit used is a stirred ball mill.

A stirred ball mill works by the rotor-stator principle and differs significantly from the form of mill that is normally understood by the term “ball mill”, even though the terminology suggests that it is a special form of the ball mill.

Stirred ball mills consist of a vertical or horizontal, usually cylindrical vessel filled to an extent of 50%-90% by volume, preferably to an extent of 70% to 90% by volume, with grinding bodies, usually consisting of steel, glass or wear-resistant ceramic materials. The vessel is the stator. The rotor is a stirrer system having suitable stirrer elements (rods or disks) or a smooth-wall stirrer body. The stirrer body is driven and ensures intensive movement of the grinding bodies. The millbase suspension, i.e. the non-platelet-shaped alloy particles, is passed continuously through the grinding space. In the course of this, the suspended alloy particles are formed and dispersed between the grinding bodies by impact forces and particularly shear forces. At the mill outlet, millbase and grinding bodies are separated by means of a suitable separating system, for example a screen.

Compared to a ball mill, the stirred ball mill brings about gentler plastic forming of the alloy particles, predominantly through shear forces.

In order to bring about gradual forming of the non-platelet-shaped metal particles to the inventive platelet-shaped anticorrosion pigments, without resulting in any significant abrasion or any comminution of the non-platelet-shaped metal particles, the process parameters (e.g. ball size, ball material, revolution rate, rotation rate, etc.) are preferably chosen such that the energy input at least 2000 kJ per kg of platelet-shaped zinc-magnesium alloy particles (kJ/kg), preferably at least 2800 kJ/kg, more preferably at least 3300 kJ/kg, even more preferably at least 3800 kJ/kg and most preferably at least 4250 kJ/kg.

The energy input can be determined, for example, by means of measuring instruments in the unit in question. Alternatively, the energy input can be determined, for example, according to formula (II) according to the following formula:

$${E}_{m} ( t ) = \frac{{\int }_{0}^{t} ( P ( τ ) - {P}_{0} ) d τ}{{m}_{P}} . \qquad ( II )$$

In this formula, Eₘ(t) is the energy input at time t, P(τ) is the power being introduced into the unit in question at time τ, P₀ is the power introduced into the unit in the absence of non-spherical metal particles (idling power) and m_{P} is the mass of the metal particles. To determine the power introduced, for example, it is possible to determine the amount of power required to drive an electric motor. The use of a stirred ball mill is especially preferred.

Moreover, it is preferable in further embodiments that the rate of energy input in the process according to the invention is at least 500 kJ per kg of platelet-shaped zinc-magnesium alloy particles (kJ/kg·h), preferably at least 580 kJ/kg·h, more preferably at least 640 kJ/kg·h, even more preferably at least 690 kJ/kg·h, and most preferably with, for example, longer continued running times at, for example, less than 100 kJ/kg·h, especially at less than 10 kJ/kg·h, the inventive forming, however, is brought about primarily by the high-energy grinding periods. It is therefore especially preferable that the 2000 kJ per kg of platelet-shaped zinc-magnesium particles or the absolute energy inputs further specified herein have been introduced in grinding periods with at least 500 kJ/kg·h, preferably at least 580 kJ/kg·h, more preferably at least 640 kJ/kg·h, even more preferably at least 690 kJ/kg·h, and most preferably at least 790 kJ/kg·h.

It is especially preferable in the aforementioned embodiments that at least 2800 kJ per kg of platelet-shaped zinc-magnesium particles (kJ/kg) are introduced at a rate of at least 580 kJ per kg of platelet-shaped zinc-magnesium particles per hour (kJ/kg·h), more preferably at least 3300 kJ/kg at a rate of at least 640 kJ/kg·h, even more preferably at least 3800 kJ/kg at a rate of at least 690 kJ/kg·h and even more at least 4250 kJ/kg at a rate of at least 790 kJ/kg·h.

Optionally, the process step of the mechanical forming of the non-platelet-shaped particles to platelet-shaped particles may be followed by a removal of the platelet-shaped zinc-magnesium alloy pigments. In addition, there may optionally follow a classification step in which a desired particle size distribution of the platelet-shaped zinc-magnesium alloy pigments is established.

The classification, for example for removal of any fines present, for example abraded material, or for establishment of a desired span AD, can be conducted, for example, by means of a cyclone, screens, etc.

The invention is illustrated in detail hereinafter with reference to the appended figures and examples, without being restricted thereto.

### FIGURES

FIGS. 1 and 2 shows scanning electron micrographs of particles according to comparative example 1.

FIGS. 3 and 4 shows a scanning electron micrograph of platelet-shaped pigments according to example 2.

FIGS. 5 and 6 shows a scanning electron micrograph of platelet-shaped pigments according to comparative example 3.

FIGS. 7 and 8 shows a scanning electron micrograph of platelet-shaped pigments according to example 4.

### EXAMPLES

### Comparative Example 1

### Zinc-Magnesium Alloy Pigments (51.4 Mol % of Zinc, 48.6 Mol % of Magnesium)

296 kg of zinc, 104 kg of magnesium were melted at a temperature of >1300° C. in an argon-inertized melting crucible. The melt was then atomized through a nozzle into a spray bunker, to obtain a powder having a particle size distribution having a D₁₀ of 6.9 μm, a D₅₀ of 16.8 μm and a D₉₀ of 34.9 μm.

9 kg of the zinc-magnesium powder were ground in 32 liters of petroleum spirit (solvent) in a ball mill (dimensions: length: 100 cm, diameter: 100 cm) and steel grinding balls (diameter 12 mm) with a speed of rotation of 40 revolutions per minute for 10 hours. Thereafter, the grinding balls and the solvent were separated from the pigments obtained. The particle size distribution was determined in a Malvern Mastersizer 2000 according to the manufacturer's instructions (D₁₀: 2.6 μm, D₅₀: 5.0 μm, D₉₀: 9.2 μm), and the median pigment thickness (h₅₀=2 μm) by means of SEM as described above and in DE 103 15 775 A1 (paragraphs [0125] to [0127]).

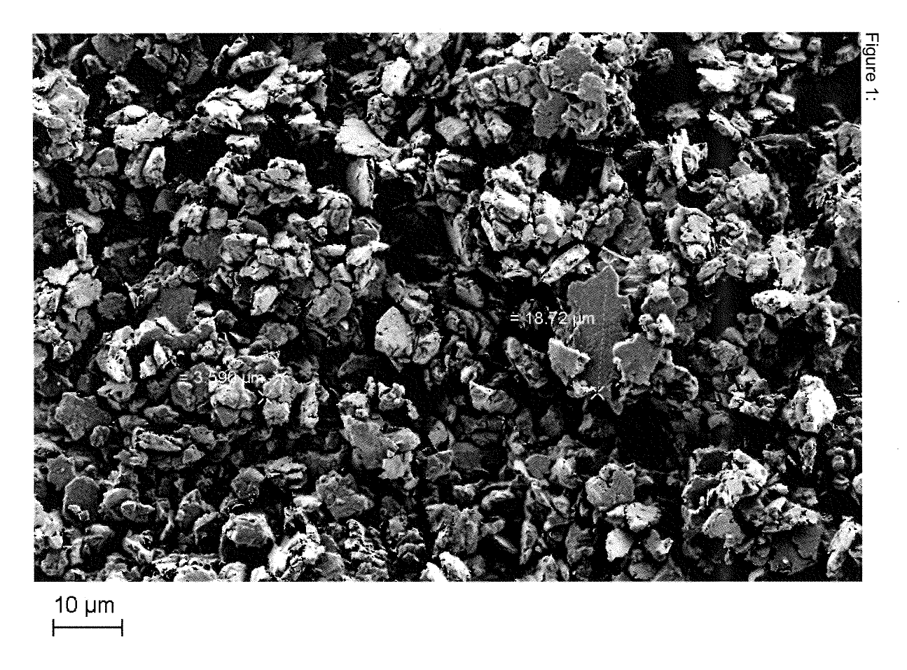

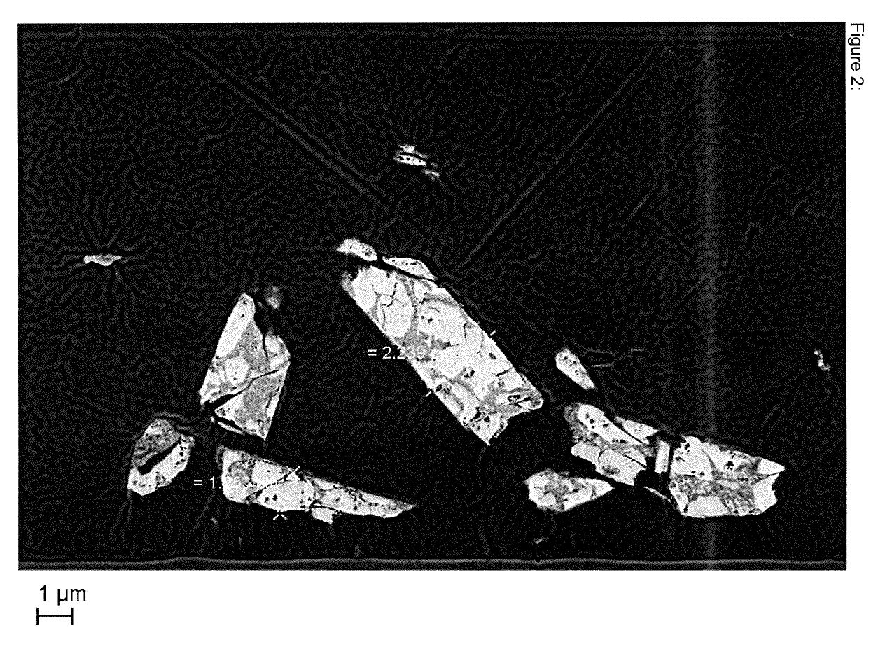

It is apparent from FIGS. 1+2 that the resultant particles are fragments and abraded material. In addition, the resultant particles have a high median pigment thickness of 2 μm. A longer grinding time did not lead to platelet-shaped pigments having a lower median pigment thickness, but merely led to further comminution of the particles.

### Example 2

### Zinc-Magnesium-Manganese Alloy Pigments (50.64 Mol % of Zinc, 48.53 Mol % of Magnesium, 0.83 Mol % of Manganese)

292 kg of zinc, 104 kg of magnesium and 4 kg of manganese were melted at a temperature of >1300° C. in an argon-inertized melting crucible. The melt was then atomized through a nozzle into a spray bunker, to obtain a powder having a particle size distribution having a D₁₀ of 6.9 μm, a D₅₀ of 16.8 μm and a D₉₀ of 34.9 μm.

9 kg of the zinc-magnesium-manganese powder were ground in 32 liters of petroleum spirit (solvent) in a ball mill (dimensions: length: 100 cm, diameter: 100 cm) and steel grinding balls (diameter 4 mm) at a speed of rotation of 40 revolutions per minute for 7 hours. Thereafter, the grinding balls and the solvent were separated from the pigments obtained. The particle size distribution was determined in a Malvern Mastersizer 2000 according to the manufacturer's instructions (D₁₀: 3.5 μm, D₅₀: 9.5 μm, D₉₀: 19.1 μm). The median pigment thickness was determined by means of SEM to be 600 nm, as described above and in DE 103 15 775 A1 (paragraphs [0125] to [0127]).

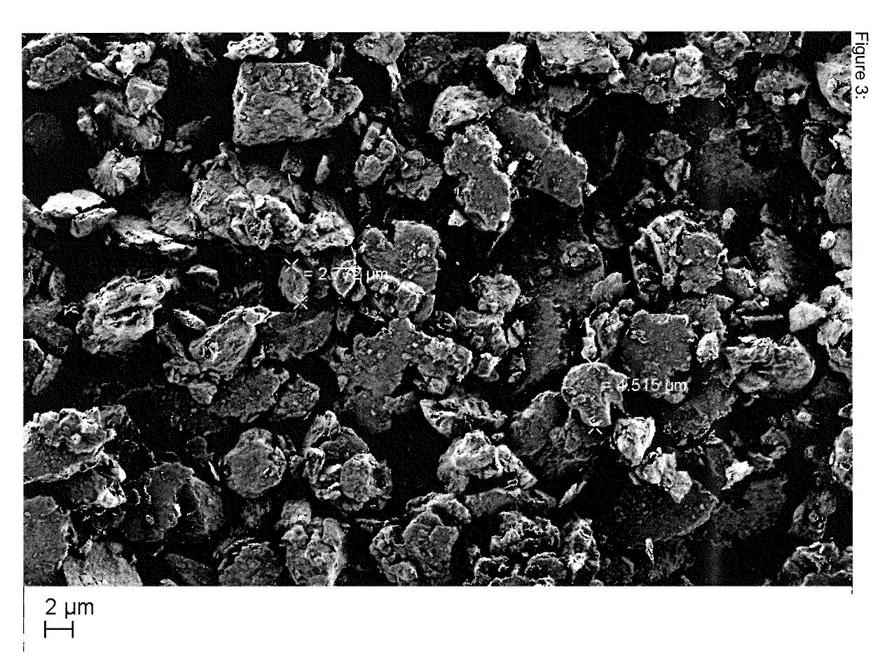

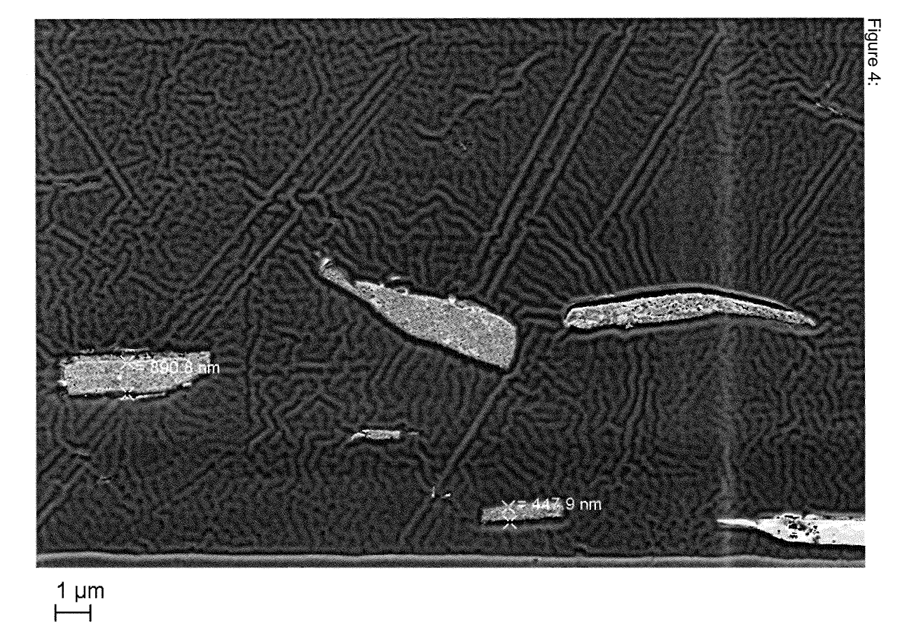

It is apparent from FIGS. 3 and 4 that the resultant pigments are platelet-shaped and contained virtually no fragments or abraded material.

### Comparative Example 3

### Zinc-Magnesium Alloy Pigments (51.4 Mol % of Zinc, 48.6 Mol % of Magnesium)

9 kg of the zinc-magnesium powder produced in comparative example 1 were ground in 32 liters of isopropanol (solvent) in a Netzsch RWK LMZ10 stirred ball mill at a specific energy input based on material Eₘ(t) of 4252.5 kJ/kg. Thereafter, the grinding balls and the solvent were separated from the pigments obtained. The particle size distribution was in a Malvern Mastersizer 2000 according to the manufacturer's instructions (D₁₀: 3.0 μm, D₅₀: 6.9 μm, D₉₀: 13.3 μm). The median pigment thickness was determined by means of SEM to be 300 nm, as described above and in DE 103 15 775 A1 (paragraphs [0125] to [0127]).

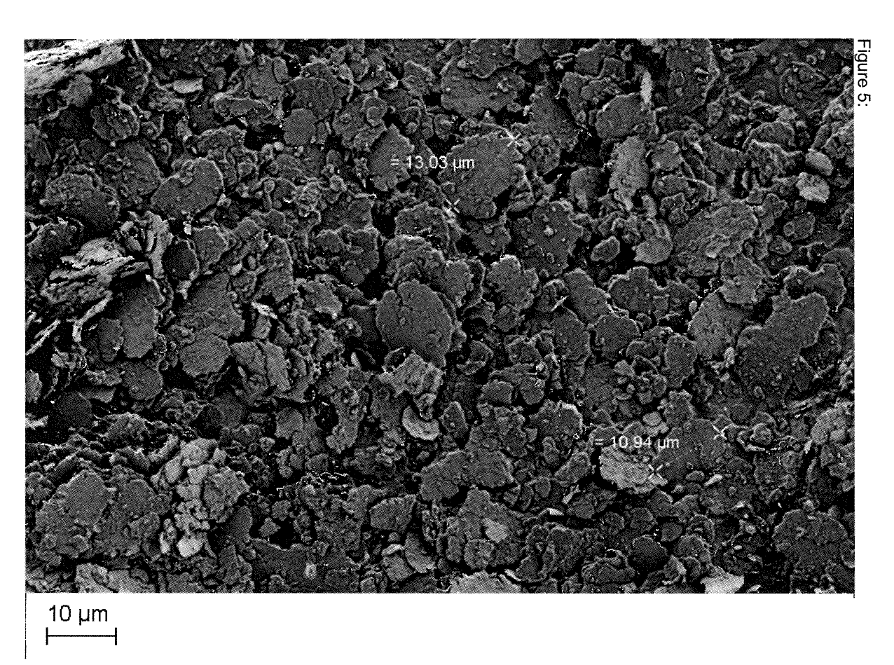

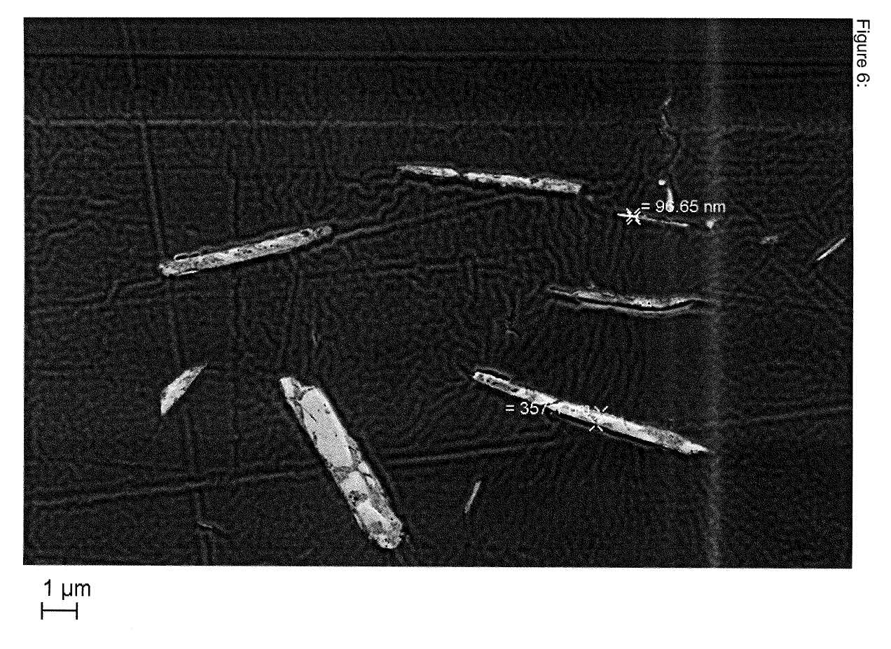

It is apparent from FIGS. 5 and 6 that the resultant pigments are platelet-shaped and contained virtually no fragments or abraded material.

### Example 4

### Zinc-Magnesium-Manganese Alloy Pigments (50.64 Mol % of Zinc, 48.53 Mol % of Magnesium, 0.83 Mol % of Manganese)

9 kg of the zinc-magnesium-manganese powder produced in example 2 were ground in 32 liters of isopropanol (solvent) in a Netzsch RWK LMZ10 stirred ball mill at a specific energy input based on material Eₘ(t) of 2835 kJ/kg. Thereafter, the grinding balls and the solvent were separated from the pigments obtained. The particle size distribution was determined in a Malvern Mastersizer 2000 according to the manufacturer's instructions (D₁₀: 3.5 μm, D₅₀: 7.1 μm, D₉₀: 14.5 μm). The median pigment thickness was determined by means of SEM to be 250 nm, as described above and in DE 103 15 775 A1 (paragraphs [0125] to [0127]).

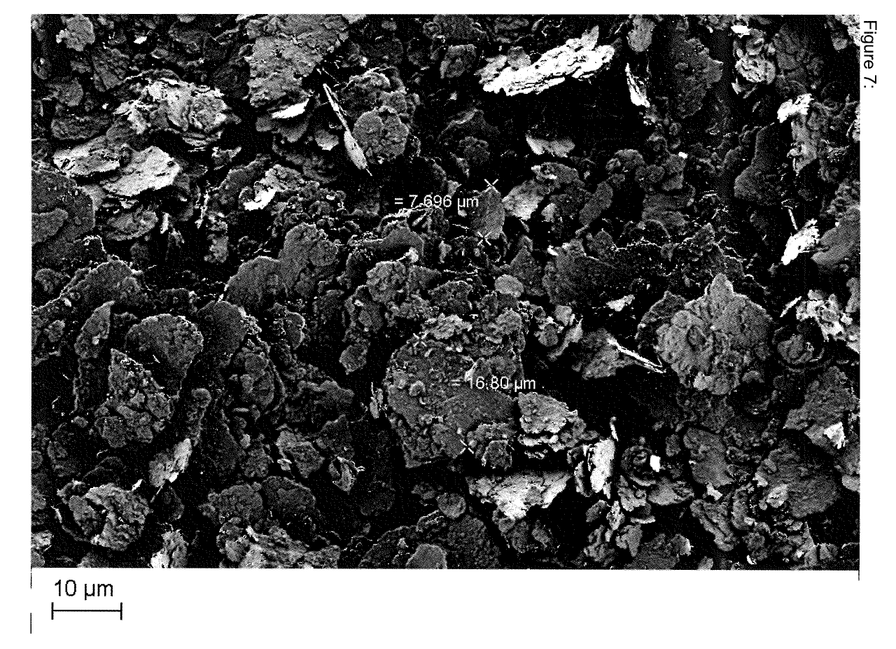

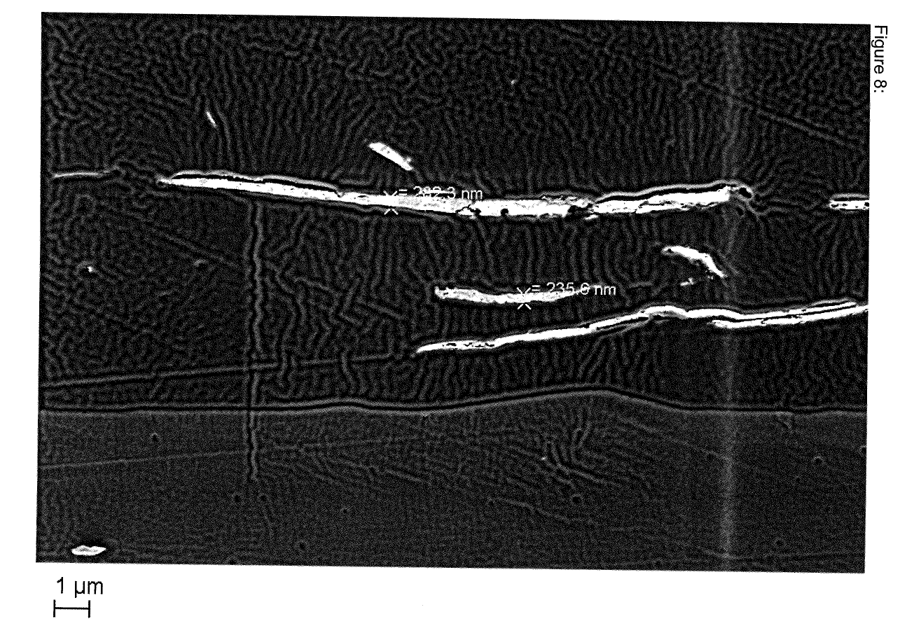

It is apparent from FIGS. 7 and 8 that the resultant pigments are platelet-shaped and contained virtually no fragments or abraded material.

### Example 5

### Zinc-Magnesium-Manganese Alloy Pigments

400 g of the zinc-magnesium-manganese powder or zinc-magnesium powder were ground in 600 ml of petroleum spirit (solvent) in a ball mill (dimensions: length: 100 cm, diameter: 100 cm) and steel grinding balls (diameter 7 mm) at a speed of rotation of 55 revolutions per minute for 7 hours. Thereafter, the grinding balls and the solvent were separated from the pigments obtained. Stearic acid was used here as lubricant. The particle size distribution was determined in a Malvern Mastersizer 2000 according to the manufacturer's instructions. The median pigment thickness was determined by means of SEM, as described above and in DE 103 15 775 A1 (paragraphs [0125] to [0127]).

| | Zn | Mg | Mn |
|---|---|---|---|
| Example 5-1 | 51.7 mol % | 47.9 mol % | 0.42 mol % |
| Example 5-2 | 51.9 mol % | 47.2 mol % | 0.84 mol % |
| Example 5-3 | 45.7 mol % | 53.5 mol % | 0.79 mol % |

| | D₁₀ | D₅₀ | D₉₀ | h₅₀ |
|---|---|---|---|---|
| Example 5-1 | 4.3 μm | 14.9 μm | 35.8 μm | 120 nm |
| Example 5-2 | 3.5 μm | 13.2 μm | 33.8 μm | 110 nm |
| Example 5-3 | 4.3 μm | 15.7 μm | 38.4 μm | 80 nm |

Through the addition of manganese to the alloy, it is easily possible to obtain flakes having a good aspect ratio. Comparative experiments without manganese added to the alloy, in contrast, showed a significantly higher tendency to fracture. Nor did a much longer grinding time in the case of the pigments with manganese result in the significant comminution observed in the case of the pigments without manganese.

Use example 1:

The pigments of examples 5-1 to 5-3 were incorporated into a test paint system comprising a basecoat and a curing agent.

The test paint system has the following composition:

Basecoat

| | | |
|---|---|---|
| ethyl 3-ethoxypropionate | 4.6 | g |
| methyl amyl ketone | 4.0 | g |
| Cymel UI-38-I (Cytec Surface Specialties) | 0.8 | g |
| DEN 431 (DOW Chemical) | 30 | g |
| Bentone 38 10% (Elementis Specialties) in | 20 | g |
| 85% xylene and 5% ethanol | | |
| MIN-U-Sil 10 (US Silica) | 6 | g |
| barium sulfate | 30 | g |
| methyl ethyl ketone | 5.5 | g |
| BYK-361-N (BYK-Chemie GmbH) | 1.2 | g |
| Z-6040 Silan (Dow Corning) | 1.7 | g |
| Pigment paste (solids content 91%) | 75 | g |

Curing agent

| | |
|---|---|
| xylene | 7.2 |
| n-butanol | 2.9 |
| Aradur 283 (Huntsman) | 23.0 |
| EH 637 Beckopox (Cytec Surface Specialties) | 5.7 |
| Ancamine K54 (Air Products) | 2.6 |
| Z-6121 Silan (Dow Corning) | 0.8 |

Subsequently, the pigmented paint systems were applied to sheets consisting of aluminum 2024 alloy, and of aluminum 2024 alloy coated with pure aluminum. These coated sheets were subjected to the Filiform test to DIN EN 3665 and assessed. All the tested pigments met the requirements of the Filiform test. Experiments with comparable pigments without manganese added to the alloy showed comparable results. The addition of manganese to the alloy therefore at least does not lead to a significant deterioration in the anticorrosive properties.

1. A platelet-shaped zinc-magnesium alloy pigment, comprising 25.1 to 76.85 mol % of Zn, 23 to 67.3 mol % of Mg, 0.15 to 7.6 mol % of at least one metal selected from the group consisting of Mn, Be, Y, Li, Sn and mixtures thereof, 0 to 5 mol % of at least one other metal selected from the group consisting of Al, Ti, Fe, Cu and mixtures thereof, based upon the total molar amount of Zn, Mg, Mn, Be, Y, Li, Sn, Al, Ti, Fe and Cu, and, wherein the molar percentages add up to 100 mol %.

2. The platelet-shaped zinc-magnesium alloy pigment according to claim 1, wherein the platelet-shaped zinc-magnesium alloy pigment comprises 32.5 to 72.09 mol % of Zn, 27.7 to 61.8 mol % of Mg, 0.18 to 6.3 mol % of at least one metal selected from the group consisting of Mn, Be, Y, Li, Sn and mixtures thereof and 0 to 4.2 mol % of at least one other metal selected from the group consisting of Al, Ti, Fe, Cu and mixtures thereof, based upon the total molar amount of the Zn, Mg, Mn, Be, Y, Li, Sn, Al, Ti, Fe and Cu, and, wherein the molar percentages add up to 100 mol %.

3. The platelet-shaped zinc-magnesium alloy pigment according to claim 1, wherein the platelet-shaped zinc-magnesium alloy pigment comprises 0.21 to 5.7 mol % of at least one metal selected from the group consisting of Mn, Be, Y, Li, Sn and mixtures thereof and 0 to 3.7 mol % of at least one other metal selected from the group consisting of Al, Ti, Fe, Cu and mixtures thereof, based upon total molar amount of Zn, Mg, Mn, Be, Y, Li, Sn, Al, Ti, Fe and Cu.

4. The platelet-shaped zinc-magnesium alloy pigment according to claim 1, wherein the platelet-shaped zinc-magnesium alloy pigment has a median thickness ranging from 70 nm to less than 700 nm.

5. The platelet-shaped zinc-magnesium alloy pigment according to claim 1, wherein the platelet-shaped zinc-magnesium alloy pigment has a median diameter D₅₀ ranging from 3.5 to 25 μm.

6. The platelet-shaped zinc-magnesium alloy pigment according to claim 1, wherein the platelet-shaped zinc-magnesium alloy pigment has an aspect ratio within a range from 10 to 200.

7. The platelet-shaped zinc-magnesium alloy pigment according to claim 1, wherein the platelet-shaped zinc-magnesium alloy pigment has pigments an aspect ratio within a range from 15 to 75.

8. A plurality of platelet-shaped zinc-magnesium alloy pigments according to claim 1, wherein the platelet-shaped zinc-magnesium alloy pigments have a size distribution having a span ΔD according to formula (I)
span ΔD=(D₉₀−D₁₀)/D₅₀ (I)
of 1 to 2.30.

9. The platelet-shaped zinc-magnesium alloy pigment according to claim 1, wherein the platelet-shaped zinc-magnesium alloy pigment comprises 42.3 to 51.1 mol % of Zn, 40.2 to 50.5 mol % of Mg, 0.4 to 2.3 mol % of Mn, 0 to 4 mol % of at least one metal selected from the group consisting of Be, Y, Li, Sn, Al, Ti, Fe and Cu,
wherein the molar percentages are based on the total molar amount of Zn, Mg, Mn, Be, Y, Li, Sn, Al, Ti, Fe and Cu,
wherein the molar percentages add up to 100 mol %, and
wherein the platelet-shaped zinc-magnesium alloy pigment has a median thickness of 110 nm to 430 nm.

10. The platelet-shaped zinc-magnesium alloy pigment according to claim 1, wherein the platelet-shaped zinc-magnesium alloy pigment is obtained by mechanical forming by means of stirred ball mills as grinding unit.

11. An anticorrosion coating, wherein the anticorrosion coating comprises the platelet-shaped zinc-magnesium alloy pigment of claim 1.

12. A coating for aircraft or coil coating, comprising the platelet-shaped zinc-magnesium alloy pigment according to claim 1.

13. An article comprising the-zinc-magnesium alloy pigment according to claim 1.

14. The article according to claim 13, wherein the article is selected from the group consisting of aircraft, ships, boats, vehicle bodies, buildings, facades, door and window frames, bridges, power masts and wind turbines.

15. The article according to claim 13, wherein the article comprises aluminium or an aluminium alloy.

16. A process for producing platelet-shaped anticorrosion pigments according to claim 1, wherein the process comprises:
mechanical forming of non-platelet-shaped particles; wherein the step comprises 25.1 to 76.85 mol % of Zn, 23 to 67.3 mol % of Mg, 0.15 to 7.6 mol % of at least one metal selected from the group consisting of Mn, Be, Y, Li, Sn and mixtures thereof, 0 to 5 mol % of at least one other metal selected from the group consisting of Al, Ti, Fe; Cu and mixtures thereof, based upon the total molar amount of Zn, Mg, Mn, Be, Y, Li, Sn, Al, Ti, Fe and Cu, and wherein the molar percentages add up to 100 mol %.

17. A process for protecting an article comprising aluminium or an aluminium alloy from corrosion, comprising coating the article with a coating comprising zinc-magnesium pigments according to claim 1.

18. An article comprising an anticorrosion coating according to claim 11.

19. The anticorrosion coating according to claim 11, wherein the platelet-shaped zinc-magnesium alloy pigment has a zinc to magnesium ratio within the range of 0.75:1 to 1.35:1.
